(19) United States
(12) Patent Application Publication
(10) Pub. No.: US 2003/0033185 A1
(43) Pub. Date: Feb. 13, 2003

(54) Method for matching a user to a subscriber

(76) Inventors: Kevin R. Leto, Boca Raton, FL (US); Brian D. Virgo, Pompano Beach, FL (US); Joshua M. Goode, Davie, FL (US)

Correspondence Address: Robert M. Schwartz, Esq., RUDEN, McCLOSKY, SMITH, SCHUSTER & RUSSELL, P.A., 200 EAST BROWARD BOULEVARD, FORT LAUDERDALE, FL, 33301, US

(21) Appl. No.: 10/201,003

(22) Filed: Jul. 23, 2002

Related U.S. Application Data
(60) Provisional application No. 60/308,021, filed on Jul. 26, 2001.
(60) Provisional application No. 60/372,674, filed on Apr. 15, 2002.

(51) Int. Cl. G06F 17/60

(52) U.S. Cl. 705/8

(57) ABSTRACT

A method for matching a user to a subscriber is disclosed that includes the steps of accessing a secure communications system by a user, inputting at least one user job profile into the secure communications system by the user, storing the at least one user job profile in a database within the secure communications system, accessing the secure communications system by at least one subscriber, inputting a subscriber profile into the secure communications system by the at least one subscriber, storing the subscriber profile in the database within the secure communications system, correlating the subscriber profile to a the user job profile to produce a job match, communicating the job match to at least one subscriber, inputting a job match reply by the at least one subscriber in response to the job match, communicating the job match reply to said secure communications system by said at least one subscriber, correlating the job match reply to the job match to determine a job acceptance, storing the job acceptance in the database within the secure communications system, generating a job acceptance confirmation in response to the job acceptance, and communicating the job acceptance confirmation to the user.

### CROSS-REFERENCES TO RELATED APPLICATIONS

This application claims the benefit of U.S. Provisional Application Serial No. 60/308,021, filed on Jul. 26, 2001, entitled METHOD FOR MATCHING A USER TO A SUBSCRIBER and 60/372,674, filed on Apr. 15, 2002, entitled METHOD FOR MATCHING A USER TO A SUBSCRIBER.

### TECHNICAL FIELD OF THE INVENTION

The present invention generally relates to a method for providing an interactive computer-driven employment matching service. More specifically, the present invention relates to a method that enables an employer user to engage a computer network, such as the Internet, to input available positions that the network subsequently transmits to an employee subscriber, the employee subscriber then accepting or declining the available position and transmitting a message to the network regarding the same.

### BACKGROUND OF THE INVENTION

The Internet is a global system of interconnected computer networks. The Internet enables computer devices of all types, from pagers to servers, to function as a unit, imparting information and communicating directly with one another. The Internet is presently configured to enable communications services between commercial, private and governmental entities. Communications over the Internet is accomplished by defined communication protocols. The World Wide Web is a tier of the Internet that employs a file transfer program (“HTTP”) protocol to allow for communication.

Presently, there exist vast resources to aid employers in locating appropriate candidates to fill vacant positions. Employers accomplish one of the more common methods of recruiting through direct advertising. In this method, the employer places a job announcement in the employment section of a newspaper, magazine, or trade journal that is targeted to people having specific skills, such as nurses, attorneys, and computer programmers. These job announcements will typically include a concise description of the position, along with the contact information of the employer. Potential job candidates may then apply for the position by providing their resumes directly to the employer through the use of electronic mail, facsimile, or regular mail. The employer, in order to identify the applicants best suited for the position, then reviews the resumes.

There are numerous inherent disadvantages in this traditional recruiting method. Initially, a response to a job announcement in a publication is limited to the number of purchasers of that publication. Moreover, most publications only service a narrow area. As a result, many qualified people outside of that region may never see the job announcement. To distribute the job announcement more effectively, the employer may be required to place the job announcement in multiple publications, substantially escalating advertising expense.

Furthermore, the traditional method is also extremely inefficient once the employer receives the resumes. Resumes obtained through this method must be organized and screened manually by individuals associated by the employer. Such individuals may be required to allocate a considerable amount of time to perform the screening process. In a considerable business where many positions are frequently available, the volume of resumes may necessitate several individuals to devote most of their time to the screening process. Additionally, due to the tremendous number of resumes that may be received, a particular resume may go unnoticed or mismanaged as a result of human error. This could result in a potential candidate failing to be considered for a position for which she or he is well suited.

An additional disadvantage of the aforementioned traditional method requires a potential candidate to constantly monitor the job announcements in order to determine the availability of a desired position. Thus, an employer or potential candidate may retain a professional recruiter to find suitable candidates for employers or desired positions potential candidates.

Whether a recruiter has been retained by an employer to locate suitable candidates for an available position, or by a potential candidate to find a desired position, the recruiter must engage in practices such as “cold calling” and networking with other recruiters to obtain names of potential candidates or locations of desired positions. Therefore, it is likely that a recruiter will fail to obtain listings of many available positions and suitable candidates alike. Furthermore, as a result of the substantial fees recruiters typically charge for their services, many employers and potential candidates are disinclined to retain a recruiter.

In efforts to capitalize on companies attempting to streamline their recruiting practices, various software companies have developed resume-screening programs that can monitor a collection of resumes for the most qualified candidates. This software scans and stores resumes in a database of a computer. The computer operating the resume screening software can then query the stored resumes for a number of qualities, including degrees earned, experience, and the like. The software will then generate a record of the best-suited candidates from the stored resumes. This computer implemented screening and categorization method can reduce the amount of time required to locate potential candidates.

Although the resume-screening software may be useful once the company has received a resume, the software does not provide for the advertising of available positions. The employer is thus forced to engage either the traditional method of publication advertising or a more recently developed method—using the Internet in order to solicit and receive resumes.

Numerous employers are using computer networks, such as the Internet, to post employment opportunities to amplify the scope of their advertising. An employer may set up a web site on the World Wide Web where job announcements can be placed. Potential candidates with access to the Internet can thereby gain access to the employer's web site to identify available positions. After a desired position is found, the potential candidate can transmit a resume to the employer via electronic mail, facsimile, or regular mail.

While a web site may facilitate an expansion of a given employer's job advertising potential, it fails to arrange or screen resumes received. The obtained resumes are again arranged and screened in the usual manner. Thus, the problem of a resume being unnoticed or mismanaged is still present.

Additionally, for a potential candidate to view an employer's job announcement, the potential candidate must be aware of the employer's Internet existence. As a result, potential candidates may fail to notice a job announcement due to a lack of knowledge with respect to an employer.

These possible limitations have been recognized, and in response, various entities have created job boards on the Internet. A job board, such as the one on Monster.com, is an electronic format where resumes and job announcements are posted. A job board is advantageous in that it offers a single location where many employers and potential candidates can post and inspect job announcements and resumes, respectively.

The job board, however, is still problematic. The database for the job board provider must store all of the job announcements, resumes, and related information. Therefore, the job board provider must have access to a considerable amount of memory for the database.

Moreover, the computer must be capable of continuously accessing all stored information in order to display it on the job board. These accessing and displaying processes involve the manipulation of copious amounts of data and may slow the operation of the computer significantly. If multitudes of potential candidates are attempting to access the job board at a particular time, the excessive level of activity can adversely effect the computerized system and result in inefficient service.

Additionally, job boards are generally arranged to only allow potential candidates to submit resumes to the job board provider. The resumes are stored in a database and subsequently forwarded to the employers with positions sought by the job seeker. This results in a reduction of the confidential nature of the resumes, since the job board provider, prior to the employer, handles the resumes. This procedure results in reduction of employer confidentiality as well. Furthermore, upon receipt of the resumes, the employer must take care of the arrangement and screening processes.

Therefore, a continuing need exists for a method that will take full advantage of an employer's job advertising efforts while further providing for a reasonably secure and efficient manner of correlating candidate information to the job announcement. Additionally, a continuing need exists to assist an employer in locating available candidates rapidly and successfully. Furthermore, a need exists for a method that enables potential candidates to present their resumes to all interested employers at the time that the employer has appropriate job openings. The method should also efficiently and accurately identify and match qualified candidates to job announcements. The present invention fulfills these needs among others.

### SUMMARY OF THE INVENTION

The present invention eliminates the above-mentioned needs by providing a method of matching a user to a subscriber that identifies qualified candidates, presents job announcements to the qualified candidates, and employs a more secure and efficient matching process between users and subscribers.

In accordance with the present invention, there is provided a method for matching a user to a subscriber that includes the steps of accessing a secure communications network by a user, inputting at least one user job profile into the secure communications network by the user and storing the at least one user job profile in a database within the secure communications network.

The secure communications network further accessed by at least one subscriber. The subscriber inputs a subscriber profile into the secure communications network that then stores the subscriber profile in the database within the secure communications network.

The subscriber profile is correlated to a user job profile to produce a job match, which is then communicated to at least one subscriber. In response to the job match, the subscriber inputs a job match reply. The job match reply is then communicated to the secure communications network by the at least one subscriber. The job match reply is correlated to the job match to determine a job acceptance, which is stored in the database within secure communications network. A job acceptance confirmation is generated in response to the job acceptance and is communicated to the user.

### BRIEF DESCRIPTION OF THE DRAWINGS

FIG. 1 is a flowchart diagram of the system of the preferred embodiment of the present invention.

FIG. 2 is a flowchart diagram of a Subscriber Control Panel of the system shown in FIG. 1.

FIG. 3 is a flowchart diagram of a User Control Panel of the system shown in FIG. 1.

FIG. 4 is another flowchart diagram of the system of the preferred embodiment shown in FIG. 1.

FIG. 5 is a flowchart of the matching method according to the preferred embodiment of the present invention.

FIG. 6 is a flowchart diagram of an alternative embodiment of the present invention of FIG. 1.

FIG. 7 is a flowchart diagram of the Hospital List of the alternative embodiment.

FIG. 8 is a flowchart diagram of the Administrator Control Panel of the alternative embodiment illustrated in FIG. 6.

FIG. 9 is a flowchart diagram of the Unit Control Panel of the alternative embodiment illustrated in FIG. 6.

FIG. 10 is a flowchart diagram of the Hospital Control Panel of the alternative embodiment illustrated in FIG. 6.

FIG. 11 is a flowchart diagram of the Nurse Control Panel of the alternative embodiment illustrated in FIG. 6.

FIG. 12 is an example of a home page in accordance with the preferred embodiment shown in FIG. 1.

FIG. 13 is an example of a subscriber registration page of one embodiment of the present invention illustrated in FIG. 1.

FIGS. 14 and 15 are examples of a user registration page of one embodiment of the present invention illustrated in FIG. 1.

FIG. 16 is an example of a network access page of one embodiment of the present invention illustrated in FIG. 1.

FIG. 17 is an example of a registration verification page of one embodiment of the present invention illustrated in FIG. 1.

FIG. 18 is an example of a subscriber control panel in accordance with the preferred embodiment of FIG. 1.

FIG. 19 is an example of a subscriber schedule page of one embodiment of the present invention illustrated in FIG. 1.

FIG. 20 is an example of a subscriber electronic mail update page of one embodiment of the present invention illustrated in FIG. 1.

FIG. 21 is an example of a network access code update page of one embodiment of the present invention illustrated in FIG. 1.

FIG. 22 is an example of a user control panel in accordance with the preferred embodiment of FIG. 1.

FIG. 23 is an example of an administrator control panel in accordance with the preferred embodiment of FIG. 1.

FIG. 24 is an example of a user search page in accordance with the preferred embodiment of FIG. 4.

### DETAILED DESCRIPTION

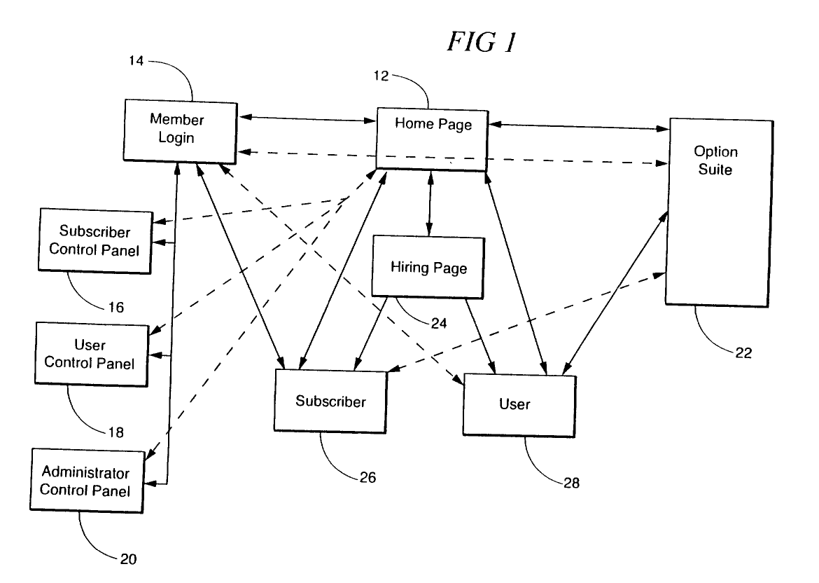

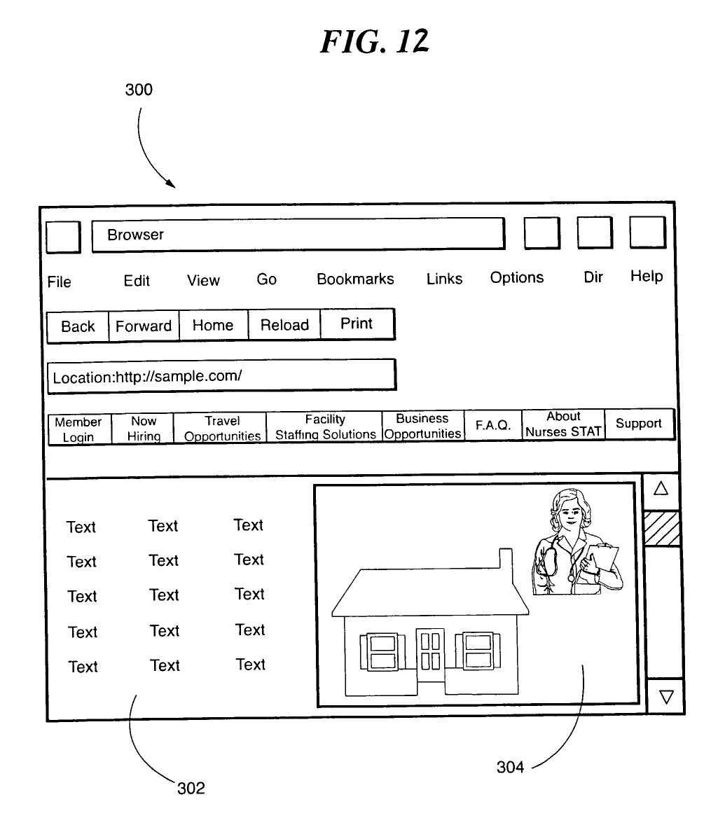

In operation, as shown in FIGS. 1, 2, 3, and 4, the method begins by a user, subscriber, or administrator accessing system 10 at Home Page 12. Home page 12, an example of which is shown also in FIG. 12 as home page 300, permits access to variety of options, including, but not limited to login pages, hiring pages, control panels, and option suites, such as technical support. Typically, a home page, such as home page 300 includes descriptive text 302 and graphics 304. In one aspect of the preferred embodiment, Home Page 12 is engaged in order to access Hiring Page 24. Hiring Page 24 allows a user or a subscriber to join the system and permits the user or subscriber to employ the system for the purpose of matching a subscriber to a user. Hiring Page 24 permits selection of a registration process, such as subscriber registration process 26 or user registration process 28.

Subscriber registration process 26 uses a HTML interface to connect to a database, which can be connected to the Internet, to register a new subscriber. Registration is accomplished by entering personal profile information, including, but not limited to, specialties, credentials, license numbers, employment history, education background, personal work preferences, emergency contact information, references, and the like via a computer. The subscriber agrees to system 10's terms and service agreement. Once a registration application is submitted the subscriber becomes a pending new subscriber. Upon submission of the registration application, an email server (not shown) for system 10 sends the pending new subscriber an email indicating that the registration application has been received by system 10 and approval or disapproval notification will follow.

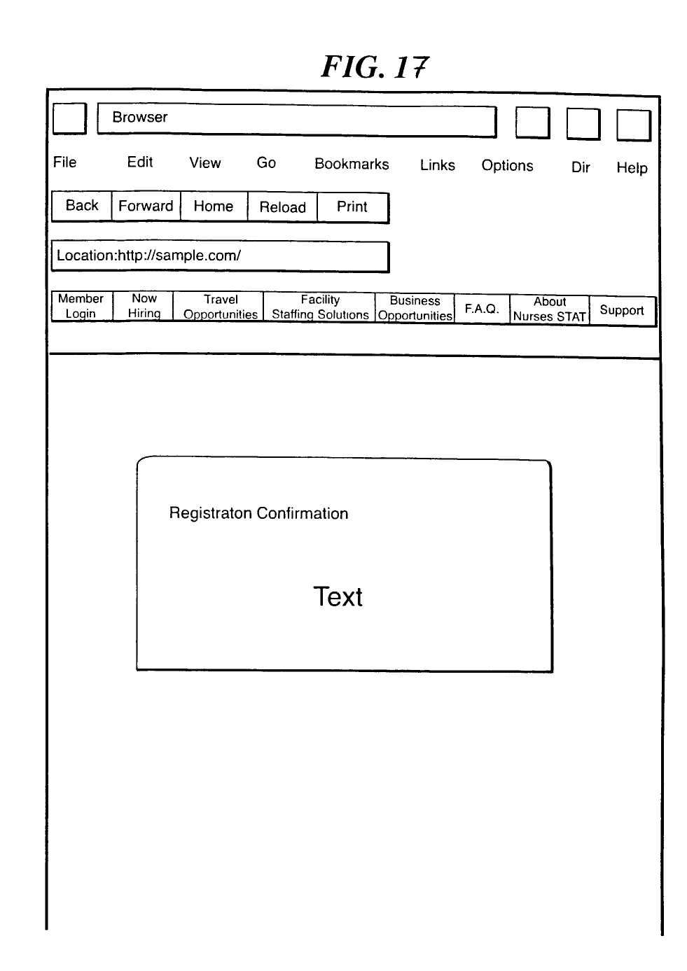

User registration process 28 also uses a HTML interface to connect to a database, which can also be connected to the Internet, to register a new user. Registration is accomplished by entering profile information, including, but not limited to, preferred user name and password, hospital information, physical and billing addresses, staffing coordinator, director of staff, and the like via a computer. The user agrees to system 10's terms and service agreement. Once a registration application is submitted the user becomes a pending new user. Upon submission of the registration application, an email server (not shown) for system 10 sends the pending new user an email indicating that the registration application has been received by system 10 and approval or disapproval email notification will follow, as is further illustrated in FIG. 17.

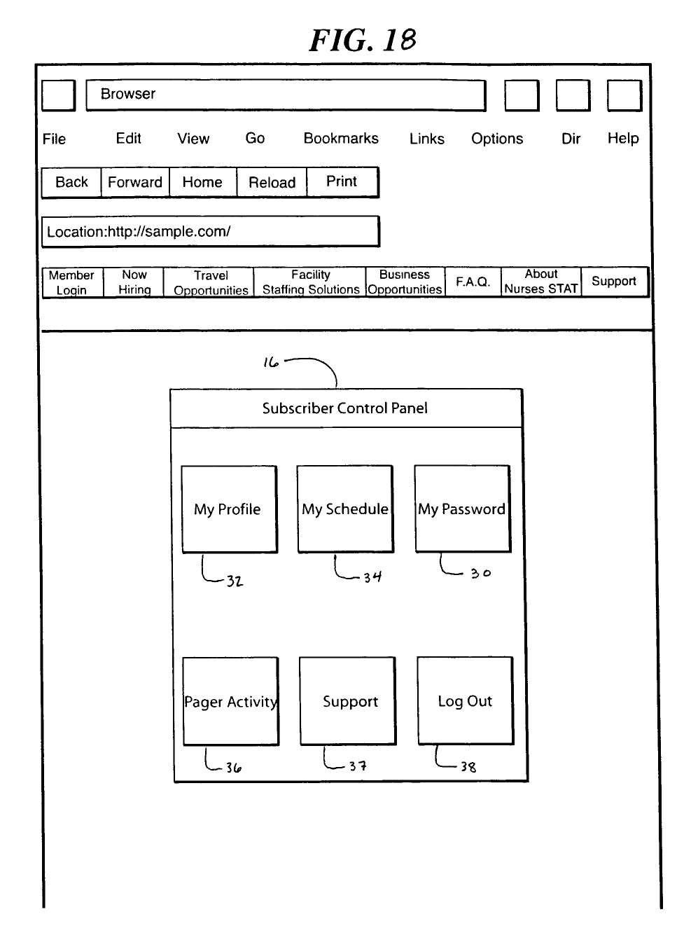

Once a subscriber completes the registration submission, Member Login Page 14 can be utilized to further access system 10. The subscriber is then required to enter a username and password or other identifier. After entering the necessary login information, the subscriber is directed to Subscriber Control Panel 16, also shown in FIG. 18. As illustrated in FIG. 18, the subscriber has the option to update or modify their information, including, but not limited to, profile information 32, schedule availability 34, and password 30. The subscriber is also able to review their pager activity 36 and requests for technical support 37, as well as log out of system 10 via Logout 38.

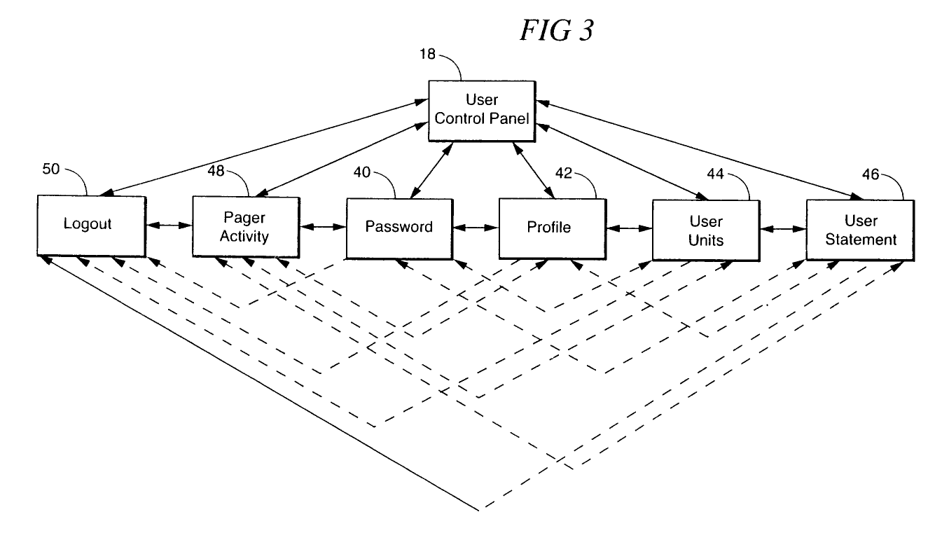

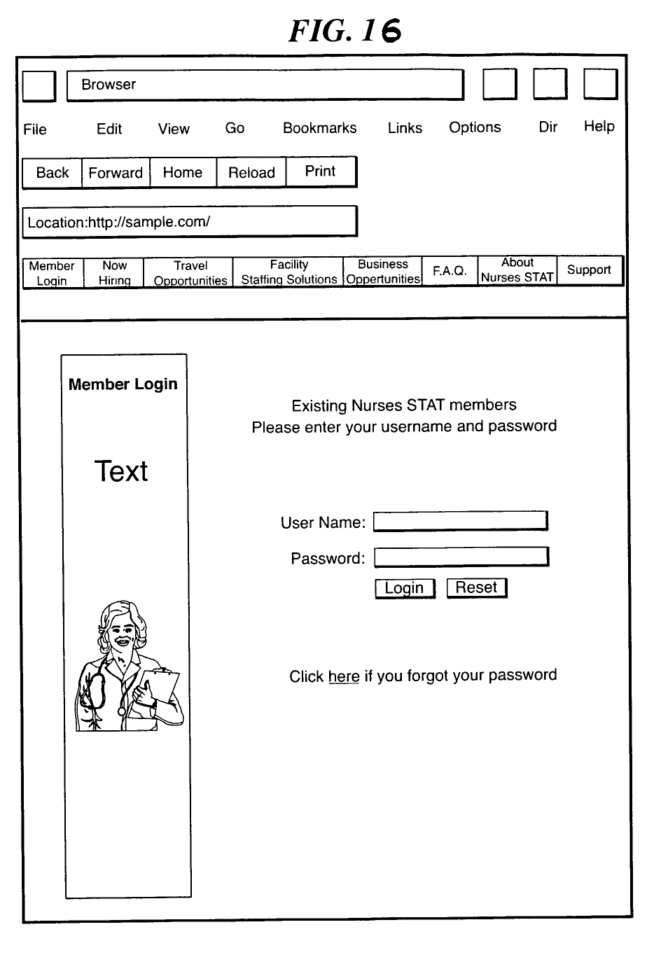

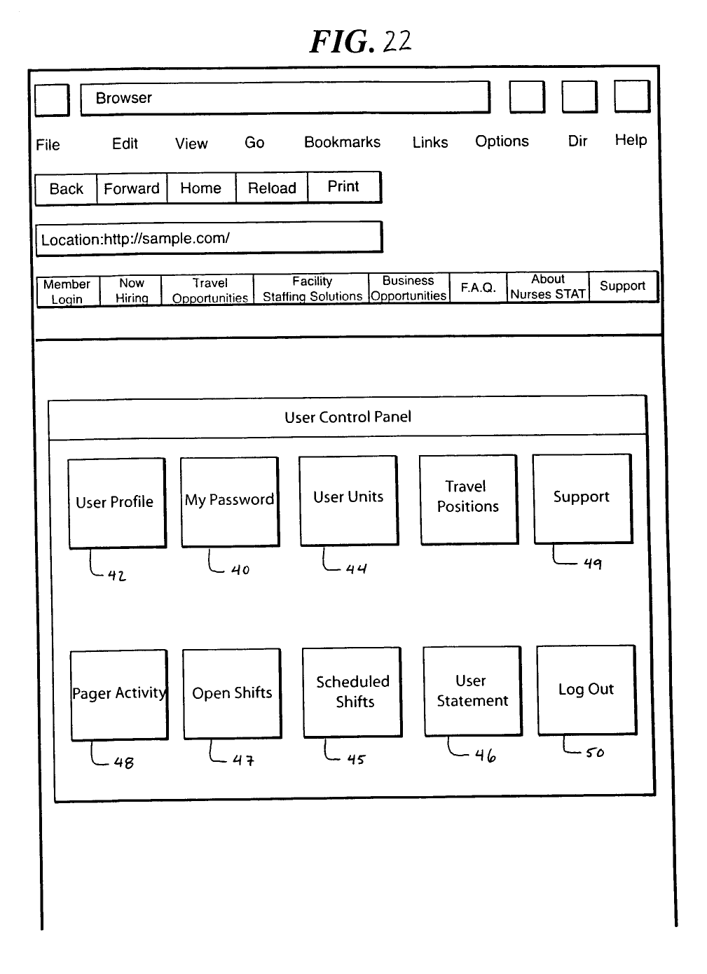

After a user completes the registration submission, Member Login Page 14 (also shown in FIG. 16) can also be utilized to further access system 10. As is illustrated in FIG. 16, the user is also required to enter a username and password or other identifier. Upon entering the necessary login information, the user is directed to User Control Panel 18, as further illustrated in FIGS. 3 and 22. The user also has the option to update or modify their profile information 42, as well as other information, including, but not limited to, user units 44, password 40, and request information for specific shifts or units via scheduled shifts 45, user statement 46, and open shifts 47. The user is also able to review pager activity 48 and request technical support 49, as well as log out of system 10 via Logout 50.

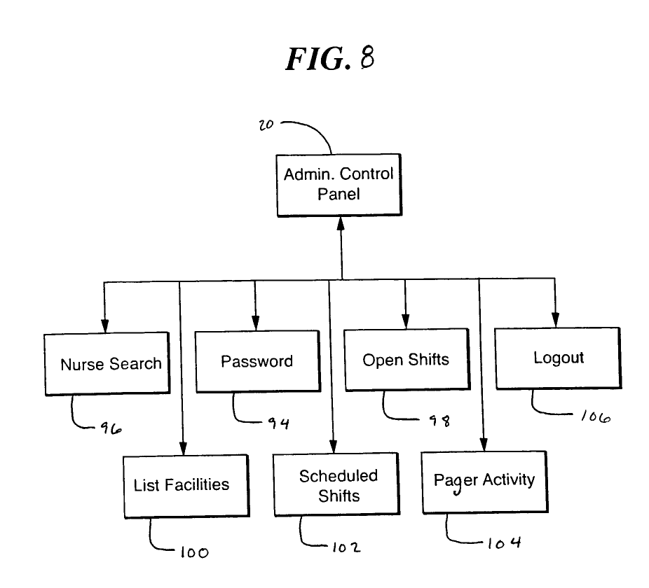

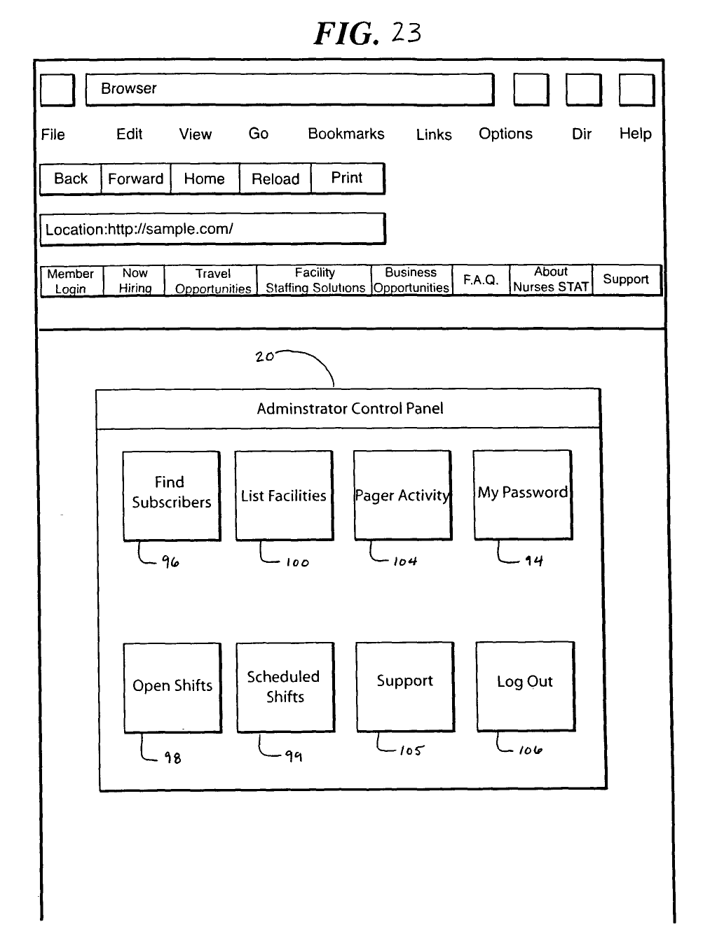

FIG. 23 illustrates Administrator Control Panel 20. Member Login Page 14 can also be utilized to access Administrator Control Panel 20. As is further illustrated in FIG. 8, upon entering the necessary login information, the user is directed to Administrator Control Panel 20 in order to modify information, including, but not limited to, search (Find Subscribers) 96, password 94, and request information for specific shifts or facilities via open shifts 98, scheduled shifts 99, and list facilities 100. The user is also able to review pager activity 104, request support 105, as well as log out of system 10 via Logout 106.

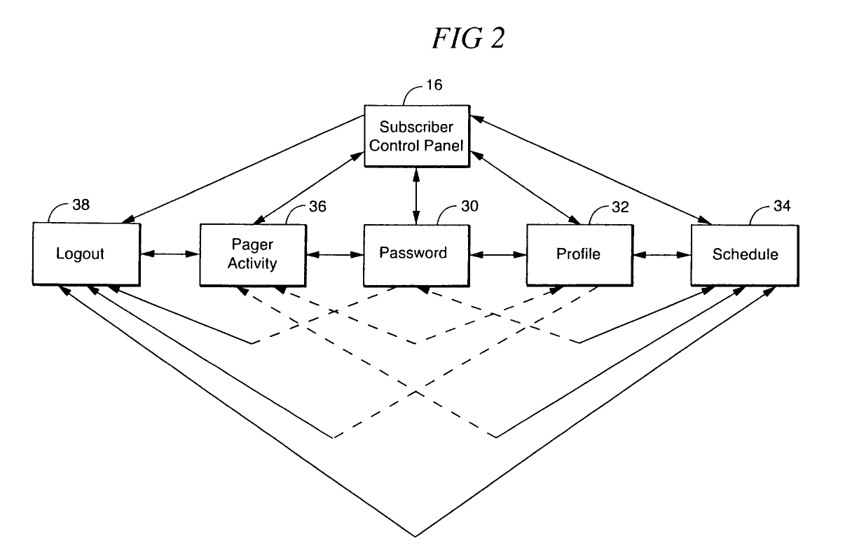

In the preferred embodiment of the present invention, as illustrated in FIG. 2, after the subscriber is logged in to system 10, the subscriber is directed to Subscriber Control Panel 16. Subscriber Control Panel 16 allows the subscriber to input a password or other identifier on Password Page 30. Once the subscriber's password is accepted by system 10, the subscriber can access their Profile Information Page 32, Schedule Page 34, Pager Activity Page 36, and Logout Page 38.

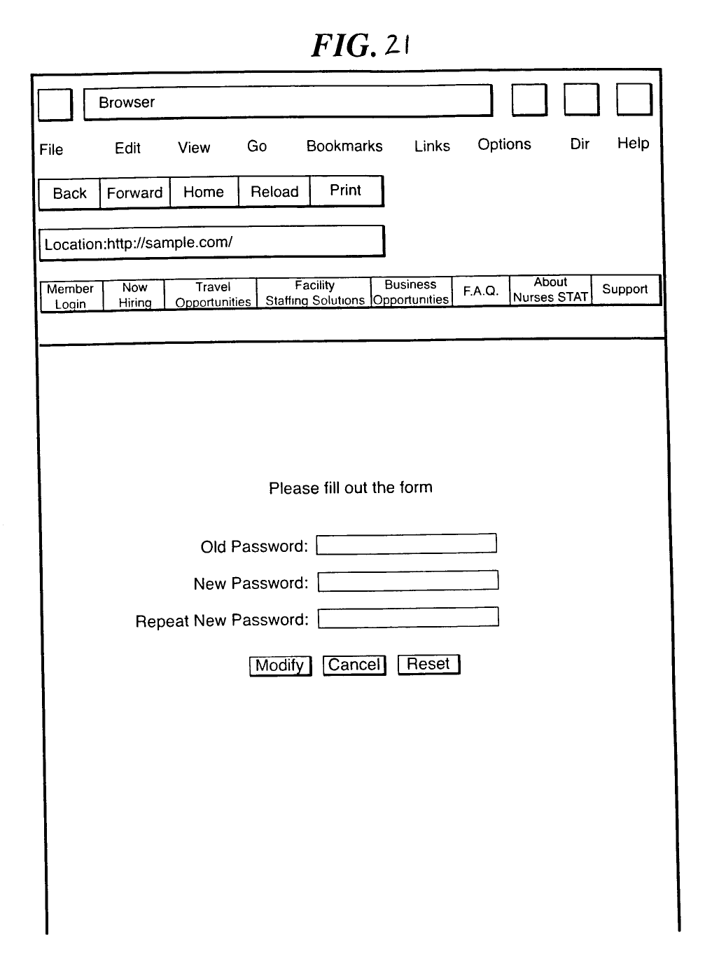

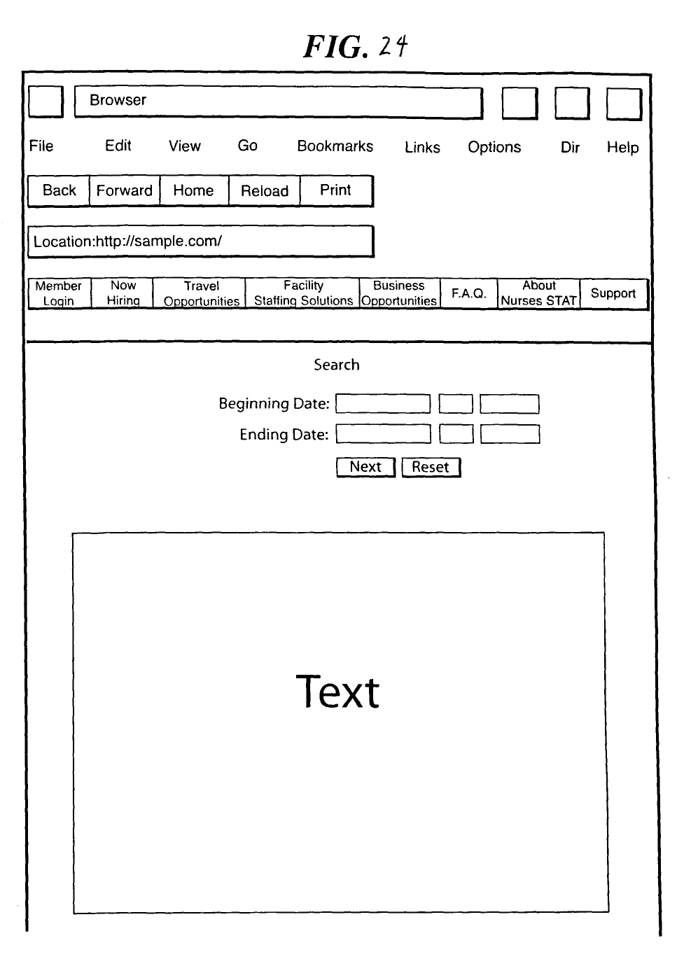

Password Page 30, an example of which is shown in FIG. 21, allows the subscriber to change from a current password to an alternate password for use in system 10. Profile Information Page 32 permits the subscriber to update their aforementioned personal profile information in real-time. Schedule Page 34 enables the subscriber to update their current work schedule information. Subscribers can enter dates and times that they want to make themselves available for work, as well as make deletions to work availability. The scheduling interface allows the subscriber to view dates and times for which they are scheduled to work. The database server also updates subscriber work schedule information in real-time. Pager Activity Page 36 permits the subscriber to review their pager activity within a specific timeframe. To enter a search, such as to view pager activity, the subscriber must enter a beginning and ending date in the fields provided, as shown in FIG. 24. Information regarding pager activity can include, but is not limited to, date and time requests, date and time responses, facility and unit information, license type and specialties, and the like. Logout function 38 allows the subscriber to exit system 10.

The database server of the preferred embodiment can track each subscriber's response to work requests. Subscriber responses will be categorized according to the total number of messages received, for example, the total number of “yes” or accepted responses, the total number of “no” or not accepted responses, and the total number of messages that lack a response. Subscribers that do not complete the required number of shifts can be tracked and removed from system 10.

In the preferred embodiment of the present invention, as illustrated in FIG. 3, after the user is logged in to system 10, the user is directed to User Control Panel 18. User Control Panel 18 allows the user to input a password or other identifier on Password Page 40. Once the user's password is accepted by system 10, the user can access their Profile Information Page 42, User Unit Page 44, User Statement Page 46, Pager Activity Page 48, and Logout Page 50.

As stated previously for the subscriber, Password Page 40 allows the user to change from a current password to an alternate password for use in system 10. Profile Information Page 42 permits the user to update the aforementioned profile information in real-time. User Units Page 44 enables the user to update the current work availability information. Users can enter dates and times that are available for work, as well as make deletions to work availability. The scheduling interface allows the user to view dates and times for which work is scheduled. The database server also updates user work schedule information in real-time. User Statement Page 46 allows an administrator to access a complete report of units located in their facility. In order to review the statement, the administrator enters the beginning and ending dates for the desired viewing period. Once these dates have been submitted, the database of system 10 will display a detailed report of all the units within that facility, as well as the statements for the dates specified. Information included within each unit can include, but is not limited to, name of the subscriber (each shift is displayed separately), check-in date and time, checkout date and time, hours worked, payment rate, and payment total. Pager Activity Page 48 permits the user to review a subscriber's pager activity within a specific timeframe. To view pager activity, the user must enter a beginning and ending date in the fields provided, as shown in FIG. 24. Information regarding pager activity can include, but is not limited to, date and time requests, date and time responses, facility and unit information, license type and specialties, and the like. Logout Page 50 allows the user to exit system 10.

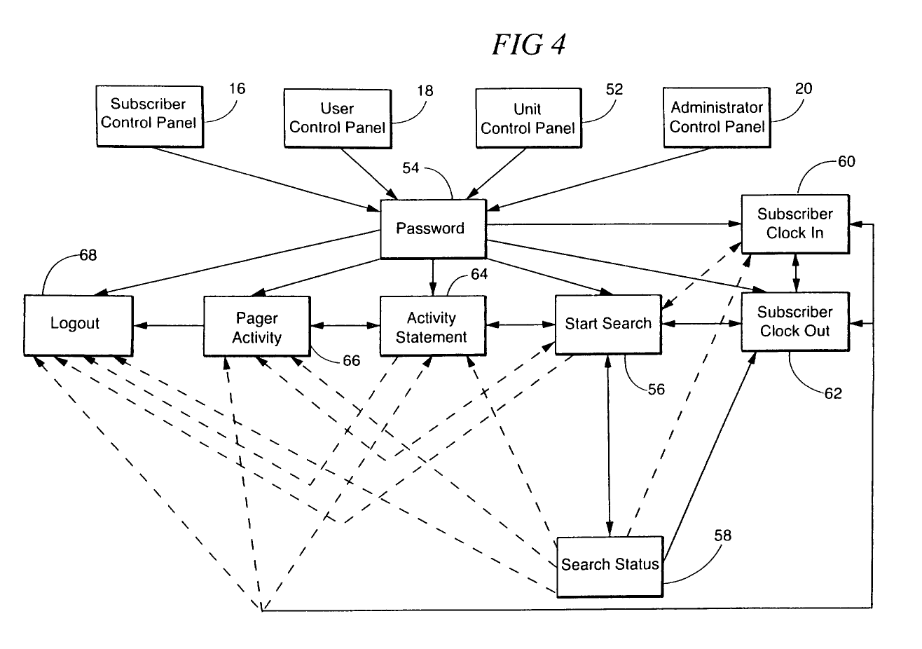

As shown in FIG. 4, Subscriber Control Panel 16, User Control Panel 18, Administrator Control Panel 20, or Unit Control Panel 52 can be used to access Password Page 54. Upon entering the appropriate password, the user, subscriber, or administrator can access an array of functions, including, but not limited to searching, monitoring subscribers, reviewing activity statements, reviewing pager activity, and logging out of system 10.

As with the subscriber and user, the administrator accesses Member Login 14, illustrated in FIG. 1. The administrator enters a username and password, as well as the necessary login information, and is directed to Administrator Control Panel 20. Administrator Control Panel 20 provides to the administrator the options to search for subscribers, users and their units, modify their password, review pager activity, and request assistance from technical support.

For example, the administrator is able to query all subscribers and users that are registered in the database, both active and suspended. When searching, the administrator may narrow the search by requesting specific fields. Complete access is given to the administrator to make necessary modifications to subscriber and/or user profiles and status. The administrator can also view results of any competency test(s) taken by a subscriber, as well as send an email to individual subscribers requesting them to take an examination. The administrator may also review the pager activity for individual subscribers for specific requested dates.

The administrator can manage all users and their corresponding units in system 10. The administrator has the ability to manage and update users and unit profiles, active status, and pager activity. Moreover, the administrator has the ability to request the pager activity of all users and their units. When making a request for pager activity, the administrator must enter a specific beginning and ending date in the fields provided. Once this is fulfilled, system 10 will allow the administrator to review all pager activity that has occurred within the time frame requested. Information regarding pager activity can include Request Date and Time, Response Date and Time, User and Unit, Subscriber, Pager, License Type and Specialties, and Response.

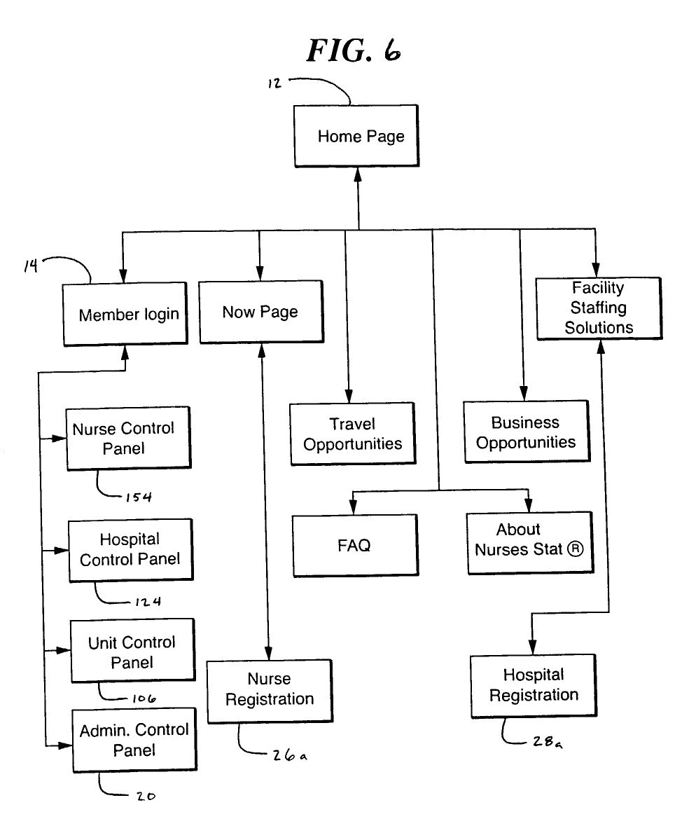

Referring now to FIGS. 6 through 11, an alternative embodiment of the present invention is illustrated. FIG. 6 that Home Page 12, as is further shown in FIG. 12, can be engaged by a nurse subscriber or hospital user to access either Nurse Registration 26a or Hospital Registration 28a, respectively. Nurse Registration 26a uses a HTML interface to connect to a database, which can be connected to the Internet, to register a new subscriber. Registration is accomplished by entering personal profile information, including, but not limited to, specialties, credentials, license numbers, employment history, education background, personal work preferences, emergency contact information, references, and the like via a computer. The nurse subscriber agrees to system 10's terms and service agreement. Once a registration application is submitted the nurse subscriber becomes a pending new nurse subscriber. Upon submission of the registration application, an email server (not shown) for system 10 sends the pending new nurse subscriber an email indicating that the registration application has been received by system 10 and approval or disapproval notification will follow.

Hospital Registration 28a also uses a HTML interface to connect to a database, which can also be connected to the Internet, to register a new user. Registration is accomplished by entering profile information, including, but not limited to, preferred user name and password, hospital information, physical and billing addresses, staffing coordinator, director of staff, and the like via a computer. The hospital user agrees to system 10's terms and service agreement. Once a registration application is submitted the hospital user becomes a pending new hospital user. Upon submission of the registration application, an email server (not shown) for system 10 sends the pending new hospital user an email indicating that the registration application has been received by system 10 and approval or disapproval email notification will follow.

Member Login 14, as stated previously and shown in FIG. 1, can be utilized to further access system 10. The nurse subscriber or hospital user is then required to enter a username and password or other identifier. After entering the necessary login information, the member, i.e., the nurse, hospital, administrator, or the like, is directed to their respective control panels, Administrator Control Panel 20, Unit Control Panel 106, Hospital Control Panel 124, and Nurse Control Panel 154.

Referring again to FIG. 8, Administrator Control Panel 20 is further described. Once accessed, Administrator Control Panel 20 permits the administrator to engage in various activities. Such activities include, but are not limited to searching for nurses 96, listing facilities 100 and open shifts 98, and listing scheduled shifts 102 and pager activity 104. Additionally, the administrator can modify password 108 and log out of system 10 through logout 106.

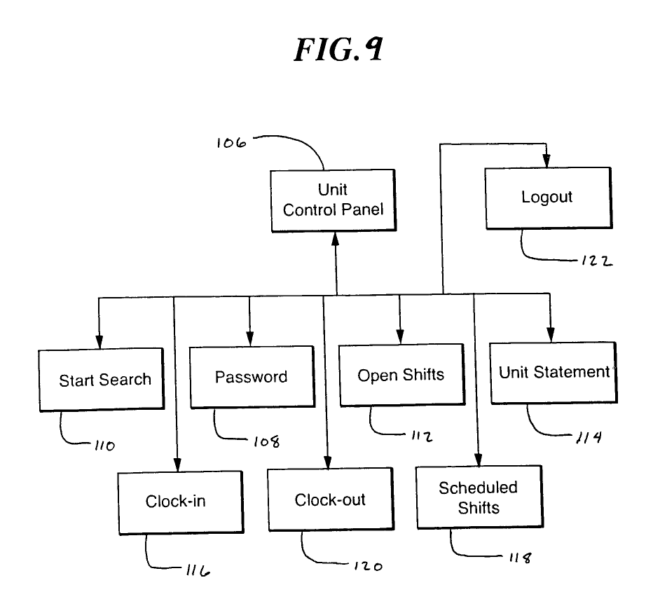

Similarly, as is shown in FIG. 9, Unit Control Panel 106 can used to provide services. Upon entering a password 108, which can also be modified, Unit Control Panel 106 can be engaged to perform a search at Start Search 110, review open shifts at Open Shifts 112, obtain a Unit Statement 114, review scheduled shifts at Scheduled Shifts 118, engage Clock-in 116 and Clock-out 120, log out at Logout 122.

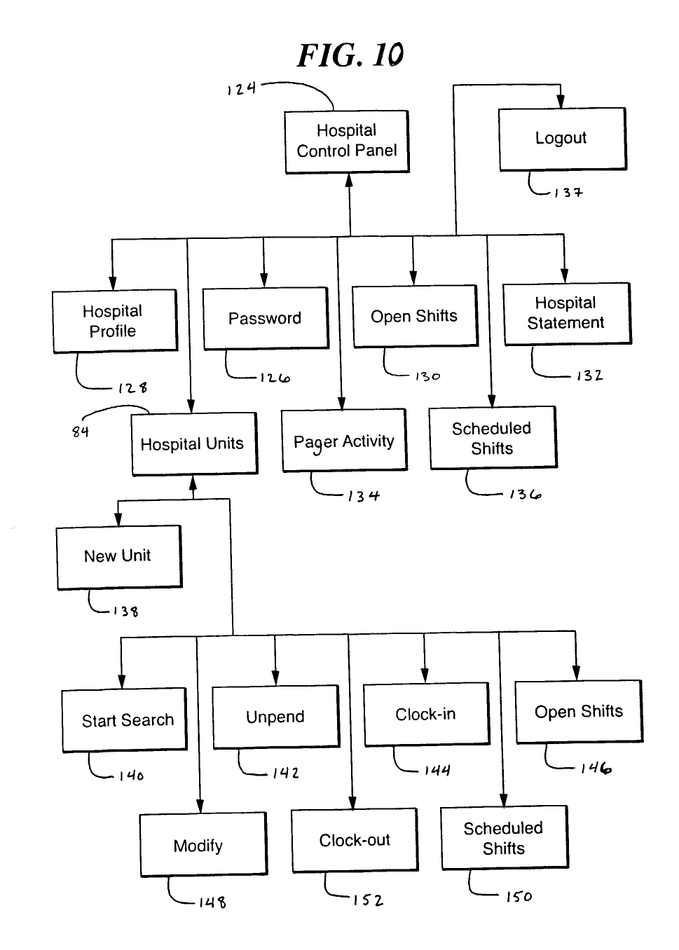

Moreover, with regard to FIG. 10, Hospital Control Panel 124 is further described. The hospital user accesses Hospital Control Panel 124 and can select a variety of options, including, but not limited to reviewing and editing Hospital Profile 128, reviewing Open Shifts 130 and Hospital Statement 132, reviewing Pager Activity 134 and Scheduled Shifts 136, and reviewing and editing Hospital Units 84. Logging out of system 10 is accomplished via Logout 137.

Should the hospital user select to edit Hospital Units 84, a New Unit 138 can be added. Moreover, units can be searched via a searching option, such as Start Search 140. Units can include open nurse positions. Once New Unit 138 is added, it is considered to be pending. Pending units can be unpended at Unpend 142. Further options may include, but are not limited to Clock-in 144, Clock-out 152, Modify 148, Open Shifts 146, and Scheduled Shifts 150.

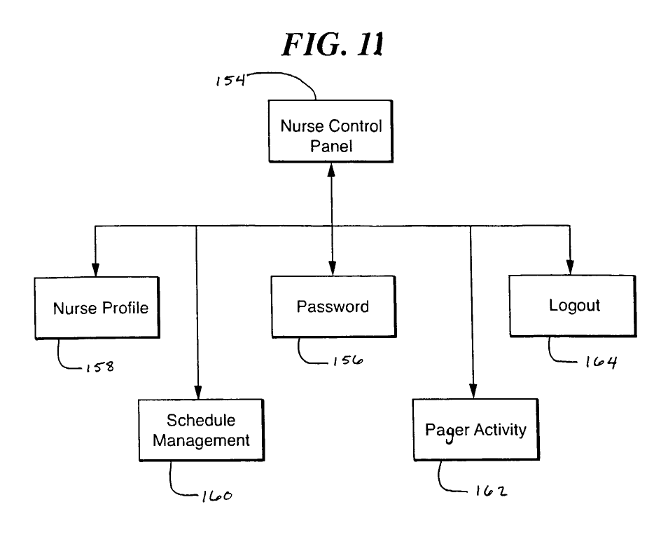

Nurse Control Panel 154, illustrated in FIG. 11, permits the nurse subscriber to review and edit a Password 156 and a Nurse Profile 158, review their schedule with Schedule Management 160, review pager activity at Pager Activity 162, and log out of system 10 via Logout 164.

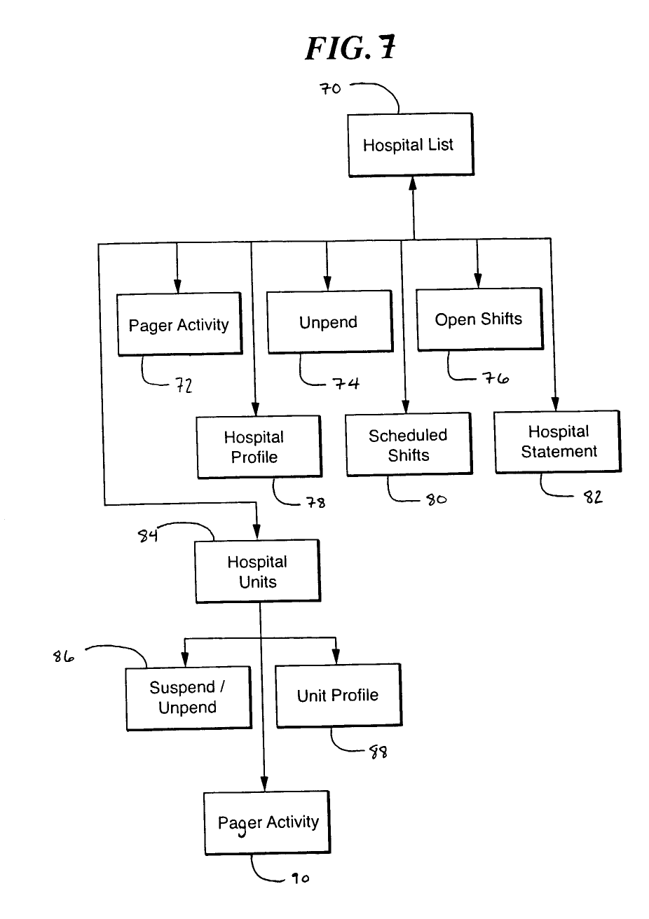

Additionally, as is shown in FIG. 7, the list of hospital users can be accessed at Hospital List 70. Hospital List 70 is a portal to review and/or edit particular information, including, but not limited to Pager Activity 72, Unpend 74 (to unpend units), Open Shifts 76, Hospital Profile 78, Scheduled Shifts 80, Hospital Statement 82, and Hospital Units 84. By selecting Hospital Units 84 via Hospital List 70, the ability to Suspend/Unpend 86 hospital units is provided, as well as the abilities to review or edit a unit profile at Unit Profile 88, and review Pager Activity 90.

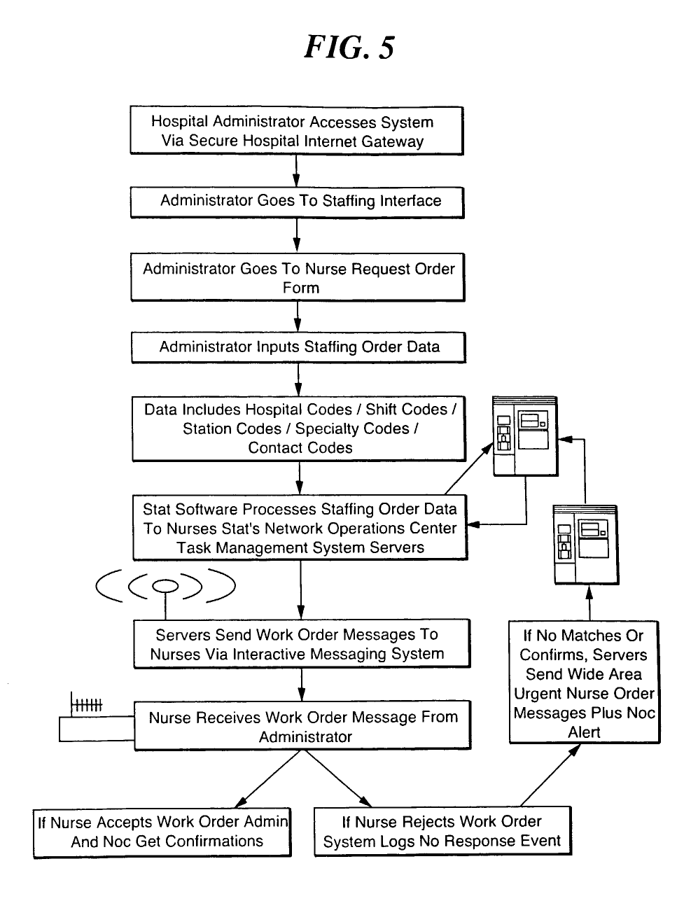

Referring now to FIG. 5, an overview of a preferred embodiment of the present invention is illustrated as a series of steps in a flow chart. The initial step allows for a user, such as a hospital administrator, to access the secure communications network of the present invention. Within the first step, a user utilizes an HTML interface while accessing on the Internet on World Wide Web to register with the matching system. This is accomplished by entering the aforementioned profile information. The profile information can include a number of required subscribers, shift requirements, specialties required, job location, contact information, and the like. The secure communications network is accessed by inputting at least one system access code, such as the above-mentioned passcode, which can be assigned by the secure communications network in response to a either a user registration or a subscriber registration.

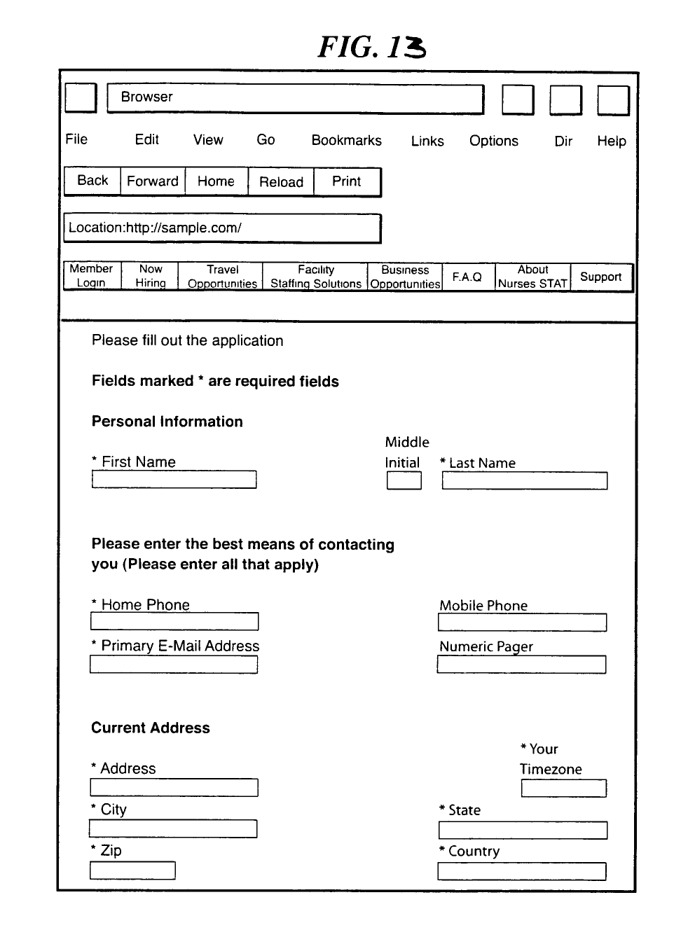

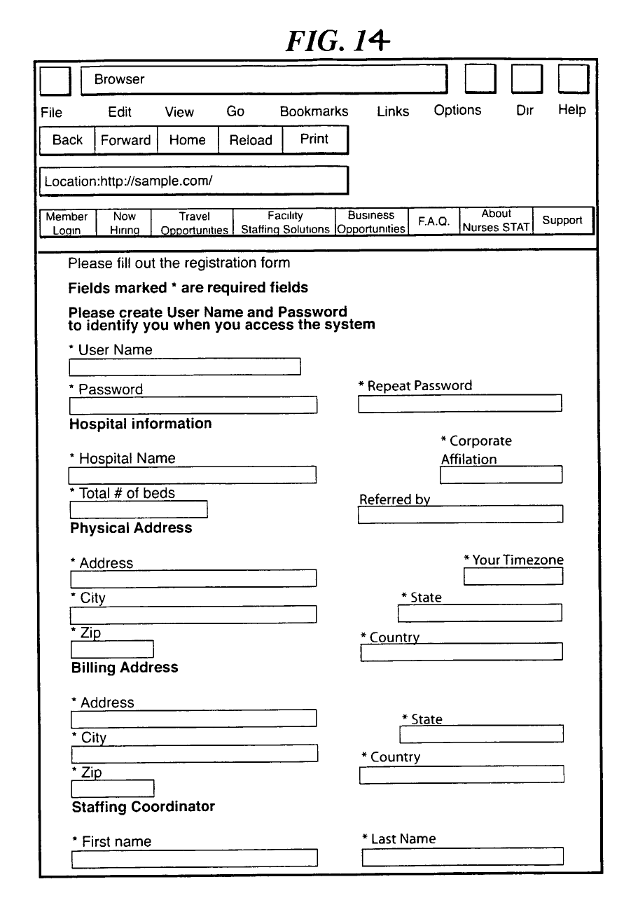

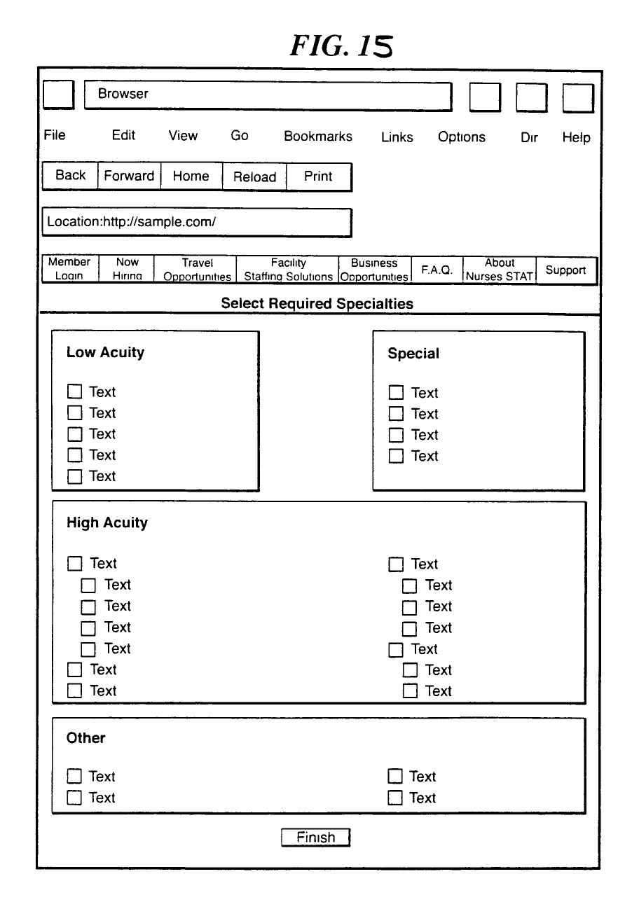

In the preferred embodiment, the system access codes are assigned by the users and subscribers in response to a registration prompt as illustrated in FIG. 16. The user or subscriber then enters profile information in fields such as those shown in FIGS. 13 through 15 to complete the registration process. As shown in FIGS. 14 and 15, the profile information for the user can include a number of required subscribers, shift requirements, specialties required, job location, contact information, and the like. As illustrated in FIG. 13, the profile information for the subscriber can include a subscriber location, personal profile information, credentials, subscriber specialties, license numbers, shift availability, and subscriber references.

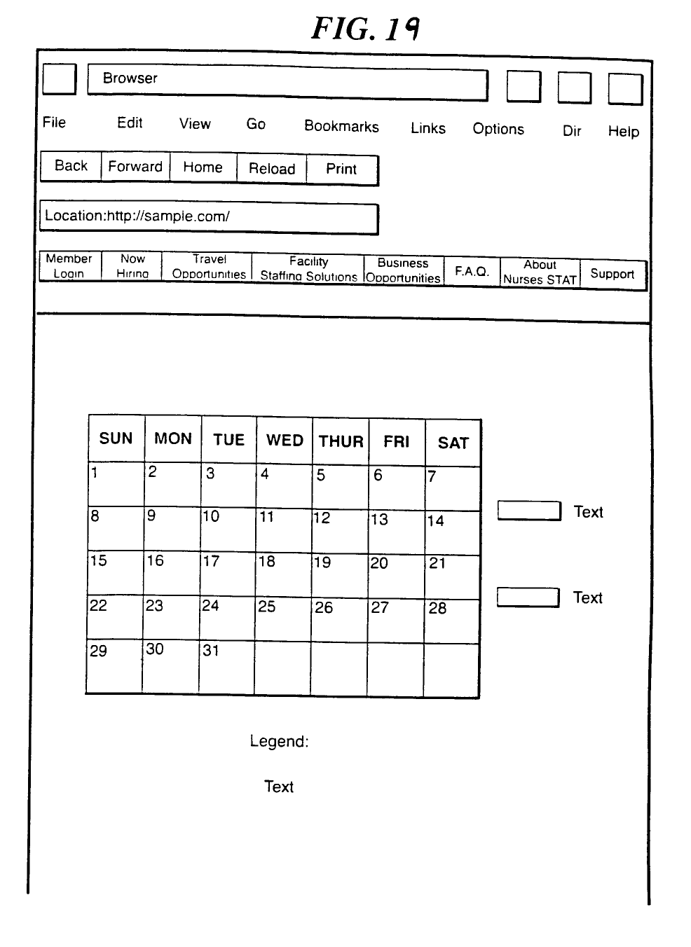

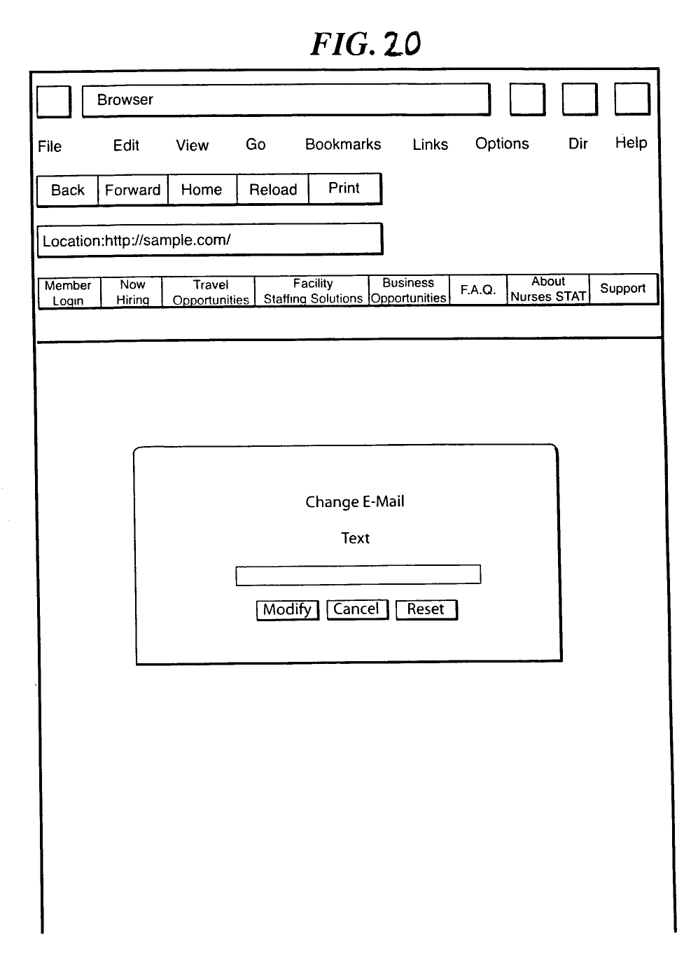

Upon completing the registration process, an automatic response registration verification message, such as the one shown in FIG. 17, is provided to the user or subscriber. Both the user and subscriber profiles can be updated, as shown in FIGS. 19 through 21, including but not limited to schedules (FIG. 19), email modifications (FIG. 20), and password modifications (FIG. 21).

The user and subscriber input all necessary information for every step of the preferred embodiment through interfaces. The interfaces can include line-based telephone interfaces, wireless telephone interfaces, wireless pager interfaces, line-base computer interfaces, and wireless computer interfaces, including personal digital assistants.

The system access codes are presented to the secure communications network by a first electronic communication that can take the form of line-based telephone transmissions, wireless telephone transmissions, wireless paging transmissions, line-based computer transmissions, and wireless computer transmissions, including personal digital assistant transmissions. The secure communications network then verifies the presented system access code. A verification that determines the validity of the system access code permits a user or subscriber to access the secure communications system.

Upon accessing system 10, the user or subscriber can choose to update their respective profiles, as in FIGS. 19 through 21, including changing their respective system access codes. Profiles are stored in non-volatile memory within the database of system 10 and correlated. The user profiles contained within the database are correlated with the subscriber profiles also contained therein. It is preferred that the correlation procedure results in at least one job match. A job match can be determined by a number of informational components of the user and subscriber profiles. The informational components that can be correlated and matched can include: job location and the subscriber location; the at least one specialty requirement of the user and the subscriber specialties; and the at least one shift requirement user and the shift availability of the subscriber.

A resulting job match is, in the third step, communicated to the matched subscribers by another electronic transmission, also originating from line-based telephone transmissions, wireless telephone transmissions, wireless paging transmissions, line-based computer transmissions, and wireless computer transmissions, including transmissions from a personal digital assistant. The job match is communicated as a preferential transmission. This preferential transmission is based on the geographic proximity of the subscriber(s) to the matched job location. The preferential transmission is distributed to a first subscriber group that includes a number of matching subscribers within a predetermined proximity to the job location. The proximity is determined by the zip code information provided by the subscriber during the registration process. Other information to determine proximity, such as telephone number, can also be used in this method.

If the system 10 garners no affirmative response to the job match from the subscriber, the preferential transmission is distributed to a second subscriber group. The subscribers in the second group are located in a second geographic region. In the fourth step, subscribers reply to the job match transmission by inputting a response into an interface. The interfaces for inputting a reply by the subscriber include line-based telephone interfaces, wireless telephone interfaces, wireless pager interfaces, line-base computer interfaces, and wireless computer interfaces, including personal digital assistants. The replies are then sent as yet another electronic transmission and can be in the form of line-based telephone transmissions, wireless telephone transmissions, wireless paging transmissions, line-based computer transmissions, wireless computer transmissions or personal digital assistant transmission. The replies can be electronic mail messages, voice data messages, facsimile messages, and automated response messages.

Replies sent by subscribers to the system 10 may be affirmative or negative. The system 10, in the fifth step, correlates the subscriber replies to the job match transmissions to determine whether a subscriber has accepted a job match. The job acceptances are stored in the database of the system 10. The process of distributing the job match in a preferential transmission is repeated until system 10 receives an affirmative reply from the required number of subscribers. The job acceptances are also stored within non-volatile memory of the database.

The sixth step has system 10 generating a job acceptance confirmation as an electronic message that can include electronic mail messages, voice data messages, and facsimile data messages. The electronic message is communicated to the user through still another electronic transmission. This electronic transmission can include line-based telephone, transmissions, wireless telephone transmissions, wireless paging transmissions, line-based computer transmissions, and wireless computer transmissions, including transmissions from personal digital assistants.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following numbered claims.

What is claimed is:

1. A method for matching a user to a subscriber, said method comprising the steps of:
accessing a secure communications system by a user;
inputting at least one user job profile into said secure communications system by said user;
storing said at least one user job profile in a database within said secure communications system;
accessing said secure communications system by at least one subscriber;
inputting a subscriber profile into said secure communications system by said at least one subscriber;
storing said subscriber profile in said database within said secure communications system;
correlating said subscriber profile to a said user job profile to produce a job match;
communicating said job match to at least one subscriber;
inputting a job match reply by said at least one subscriber in response to said job match;
communicating said job match reply to said secure communications system by said at least one subscriber;
correlating said job match reply to said job match to determine a job acceptance;
storing said job acceptance in said database within said secure communications system;
generating a job acceptance confirmation in response to said job acceptance; and
communicating said job acceptance confirmation to said user.

2. The method according to claim 1 wherein said secure communications system is accessed via at least one system access code.

3. The method according to claim 2 wherein said at least one system access code is assigned by said secure communications system in response to a registration.

4. The method according to claim 2 wherein said at least one system access code is assigned by said user in response to a user registration.

5. The method according to claim 2 wherein said at least one system access code is assigned by said subscriber in response to a subscriber registration.

6. The method according to claim 3 wherein said registration is a user registration.

7. The method according to claim 3 wherein said registration is a subscriber registration.

8. The method according to claim 3 wherein said at least one system access code is presented to said secure communications system via a first electronic communication.

9. The method according to claim 8 wherein said first electronic communication is selected from the group consisting of line-based telephone transmissions, wireless telephone transmissions, wireless paging transmissions, line-based computer transmissions, wireless computer transmissions, and personal digital assistant transmissions.

10. The method according to claim 9 wherein said at least one system access code is verified to determine a validity by said secure communications system.

11. The method according to claim 10 wherein said validity permits a system access to said secure communications system.

12. The method according to claim 1 wherein said user job profile includes a number of required subscribers.

13. The method according to claim 12 wherein said user job profile includes at least one shift requirement.

14. The method according to claim 13 wherein said user job profile includes at least one job specialty requirement.

15. The method according to claim 14 wherein said user job profile includes a job location.

16. The method according to claim 15 wherein said user job profile includes user contact information.

17. The method according to claim 16 wherein said user job profile is updated.

18. The method according to claim 17 wherein said user job profile is further stored in a job profile table within said database.

19. The method according to claim 12 wherein said job profile table is stored in non-volatile memory.

20. The method according to claim 1 wherein said user job profile is inputted into said secure communications system via a first interface.

21. The method according to claim 20 wherein said first interface is selected from the consisting of line-based telephone interfaces, wireless telephone interfaces, wireless pager interfaces, line-base computer interfaces, wireless computer interfaces, and personal digital assistant interfaces.

22. The method according to claim 1 wherein said subscriber profile includes a subscriber location.

23. The method according to claim 22 wherein said subscriber profile includes personal profile information.

24. The method according to claim 23 wherein said personal profile information includes credentials.

25. The method according to claim 24 wherein said personal profile information includes subscriber specialties.

26. The method according to claim 25 wherein said personal profile information includes license numbers.

27. The method according to claim 26 wherein said personal profile information includes shift availability.

28. The method according to claim 27 wherein said personal profile information includes subscriber references.

29. The method according to claim 28 wherein said user subscriber profile is updated.

30. The method according to claim 29 wherein said subscriber profile is further stored in a subscriber profile table within said database.

31. The method according to claim 30 wherein said subscriber profile table is stored in non-volatile memory.

32. The method according to claim 1 wherein said subscriber profile is inputted into said secure communications system via a second interface.

33. The method according to claim 32 wherein said second interface is selected from the consisting of line-based telephone interfaces, wireless telephone interfaces, wireless pager interfaces, line-base computer interfaces, wireless computer interfaces, and personal digital assistant interfaces.

34. The method according to claim 1 wherein said job match is produced by a match between said job location and said subscriber location.

35. The method according to claim 34 wherein said job match is produced by a match between said at least one specialty requirement and said subscriber specialties.

36. The method according to claim 35 wherein said job match is produced by a match between said at least one shift requirement and said shift availability.

37. The method according to claim 1 wherein said job match is communicated to at least one subscriber via a second electronic transmission.

38. The method according to claim 37 wherein said second electronic transmission is selected from the group consisting of line-based telephone transmissions, wireless telephone transmissions, wireless paging transmissions, line-based computer transmissions, wireless computer transmissions, and personal digital assistant transmissions.

39. The method according to claim 38 wherein said second electronic transmission is communicated as a preferential transmission.

40. The method according to claim 39 wherein said preferential transmission is distributed to a first subscriber group.

41. The method according to claim 40 wherein said first subscriber group is located in a first geographic region.

42. The method according to claim 41 wherein the preferential transmission is distributed to a second subscriber group.

43. The method according to claim 42 wherein the second subscriber group is located in a second geographic region.

44. The method according to claim 1 wherein said job match reply is inputted into a third interface.

45. The method according to claim 44 wherein said third interface is selected from the consisting of line-based telephone interfaces, wireless telephone interfaces, wireless pager interfaces, line-base computer interfaces, wireless computer interfaces, and personal digital assistant interfaces.

46. The method according to claim 1 wherein said job match reply is communicated to said secure communications system via a third electronic transmission.

47. The method according to claim 46 wherein said third electronic transmission is selected from the group consisting of line-based telephone transmissions, wireless telephone transmissions, wireless paging transmissions, line-based computer transmissions, wireless computer transmissions, and personal digital assistant transmissions.

48. The method according to claim 47 wherein said job match reply is an electronic message.

49. The method according to claim 48 wherein said electronic message is selected from the group consisting of electronic mail messages, voice data messages, and facsimile data messages.

50. The method according to claim 1 wherein said job acceptance is an affirmative job match reply.

51. The method according to claim 50 wherein said job acceptance is stored in a job acceptance table within said database.

52. The method according to claim 51 wherein said job acceptance table is stored in non-volatile memory.

53. The method according to claim 1 wherein said job acceptance confirmation is an electronic message.

54. The method according to claim 53 wherein said electronic message is selected from the group consisting of electronic mail messages, voice data messages, and facsimile data messages.

55. The method according to claim 54 wherein said electronic message is communicated to the user via a fourth electronic transmission.

56. The method according to claim 55 wherein said fourth electronic transmission is selected from the group consisting of line-based telephone transmissions, wireless telephone transmissions, wireless paging transmissions, line-based computer transmissions, wireless computer transmissions, and personal digital assistant transmissions.
